(19) United States
(12) Patent Application Publication
(10) Pub. No.: US 2025/0354395 A1
(43) Pub. Date: Nov. 20, 2025

(54) PRIVACY BOOTH

(71) Applicant: Herman Miller Limited, Melksham (GB)

(72) Inventors: Martin Bloomfield, Bathford (GB); Ralph Farrer, Somerset (GB); Alex Martin, Bath (GB); Gregg Elhart, Traverse City, MI (US)

(21) Appl. No.: 19/207,825

(22) Filed: May 14, 2025

Related U.S. Application Data
(60) Provisional application No. 63/648,555, filed on May 16, 2024.

(51) Int. Cl. E04H 1/12; F21V 23/04; F24F 7/013; F24F 11/00; F24F 11/77; F24F 120/14

(52) U.S. Cl. CPC E04H 1/125; F21V 23/0442; F24F 7/013; F24F 11/0001; F24F 11/77; F24F 2011/0002; F24F 2120/14

(57) ABSTRACT

A privacy booth for use in a room, the privacy booth supported by a floor of the room, the privacy booth including: a continuous wall including a plurality of panels coupled to one another, the continuous wall having a bottom edge that is configured to be spaced apart from the floor to define a gap therebetween; a ceiling coupled to the continuous wall; a door coupled to the continuous wall to enclose an interior and to selectively provide access to the interior; and a ventilation system supported by the ceiling, the ventilation system including an inlet positioned within the interior and an outlet adjacent to the ceiling and in communication with an exterior, wherein the ventilation system is configured to draw air into the interior from the exterior through the gap, draw the air from the interior into the inlet, and expel the air through the outlet to the exterior.

### CROSS-REFERENCE TO RELATED APPLICATIONS

This application is a non-provisional of and claims the benefit of U.S. Provisional Patent Application No. 63/648,555, filed on May 16, 2024, the entire contents of which are incorporated herein by reference.

### FIELD OF THE INVENTION

The present invention relates to a privacy booth for conducting, for example, telephone calls and video conferences.

### SUMMARY OF THE INVENTION

In some aspects, the techniques described herein relate to a privacy booth for use in a room, the privacy booth supported by a floor of the room, the privacy booth including: a continuous wall including a plurality of panels coupled to one another, the continuous wall having a bottom edge that is configured to be spaced apart from the floor to define a gap therebetween; a ceiling coupled to the continuous wall; a door coupled to the continuous wall to enclose an interior and to selectively provide access to the interior; and a ventilation system supported by the ceiling, the ventilation system including an inlet positioned within the interior and an outlet adjacent to the ceiling and in communication with an exterior, wherein the ventilation system is configured to draw air into the interior from the exterior through the gap, draw the air from the interior into the inlet, and expel the air through the outlet to the exterior.

In some aspects, the techniques described herein relate to a privacy booth for use in a room, the privacy booth supported by a floor of the room, the privacy booth including: a continuous wall including a plurality of sound absorbing panels coupled to one another, the continuous wall having a bottom edge that is configured to be spaced apart from the floor to define a gap therebetween; a ceiling coupled to the continuous wall; a door coupled to the continuous wall to enclose an interior and to selectively provide access to the interior; and a ventilation system supported by the ceiling, the ventilation system configured to draw air into the interior from an exterior through the gap and expel the air through an outlet adjacent the ceiling to the exterior.

In some aspects, the techniques described herein relate to a privacy booth for use in a room, the privacy booth supported by a floor of the room, the privacy booth including: a continuous wall including a plurality of panels coupled to one another, the continuous wall having a bottom edge that is configured to be spaced apart from the floor to define a gap therebetween; a ceiling coupled to the continuous wall; a door coupled to the continuous wall to enclose an interior and to selectively provide access to the interior; a control hub including a controller and a motion sensor in electrical communication with the controller; and a ventilation system supported by the ceiling and including a fan in electrical communication with the controller, the fan configured to draw air into the interior from the exterior through the gap and expel the air through an outlet adjacent the ceiling to an exterior; and wherein the controller is configured to turn on the fan upon detection of a user by the motion sensor.

Other features and aspects of the invention will become apparent by consideration of the following detailed description and accompanying drawings.

### BRIEF DESCRIPTION OF THE DRAWINGS

FIG. 1 is a perspective view of a privacy booth according to one embodiment.

FIG. 2 is a perspective view of a privacy booth according to another embodiment.

FIG. 3 is a top view of the privacy booth of FIG. 1.

FIG. 4 is a top view of the privacy booth of FIG. 2.

FIG. 5 is an exploded view of one of the panels of the privacy booth of FIG. 1 and FIG. 2.

FIG. 6 is a cross-sectional view of the privacy booth of FIGS. 1 and 2 along the line 6-6 of FIGS. 1 and 2.

FIG. 7 is a detailed view of a connector of the privacy booth of FIG. 6.

FIG. 8A is a perspective view of a first connector member of the connector of FIG. 7.

FIG. 8B is a perspective view of a second connector member of the connector of FIG. 7.

FIG. 9A is a perspective cross-sectional view of the connector of FIG. 7.

FIG. 9B is a detailed cross-sectional view of the connector of FIG. 7.

FIG. 10 is a cross-sectional view of the privacy booth of FIGS. 1 and 2 along the line 10-10 of FIGS. 1 and 2 and illustrates a portion of an interior of the privacy booth.

FIG. 11 is a bottom view of a desk of the privacy booth of FIGS. 1 and 2.

FIG. 12 is a detailed view of a portion of the privacy booth of FIGS. 1 and 2.

FIG. 13 is a cross-sectional view of the privacy booth of FIGS. 1 and 2 with a desk located at a first height.

FIG. 14 is a cross-sectional view of the privacy booth of FIGS. 1 and 2 with the desk located at a second height.

FIG. 15 is a cross-sectional view of the privacy booth of FIGS. 1 and 2 illustrating an airflow through a fan.

FIG. 16A is a perspective view of a ventilation system of the privacy booth of FIGS. 1 and 2.

FIG. 16B is a perspective view of the ventilation system of FIG. 16A.

FIG. 17A is a partially exploded view of the ventilation system of FIG. 16A.

FIG. 17B is a perspective view of a portion of the ventilation system of FIG. 16A.

FIG. 18 is a detailed view of a portion of the privacy booth of FIG. 1 and FIG. 2.

FIG. 19 is another detailed view of a portion of the privacy booth of FIG. 1 and FIG. 2.

FIG. 20 is another detailed view of a portion of the privacy booth of FIG. 1 and FIG. 2.

FIG. 21 is a schematic view of components of the privacy booth of FIGS. 1 and 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

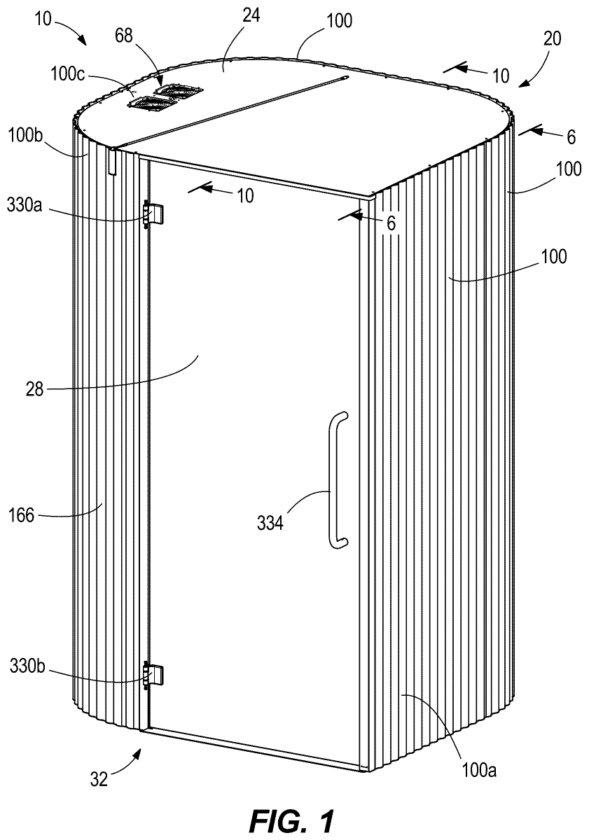

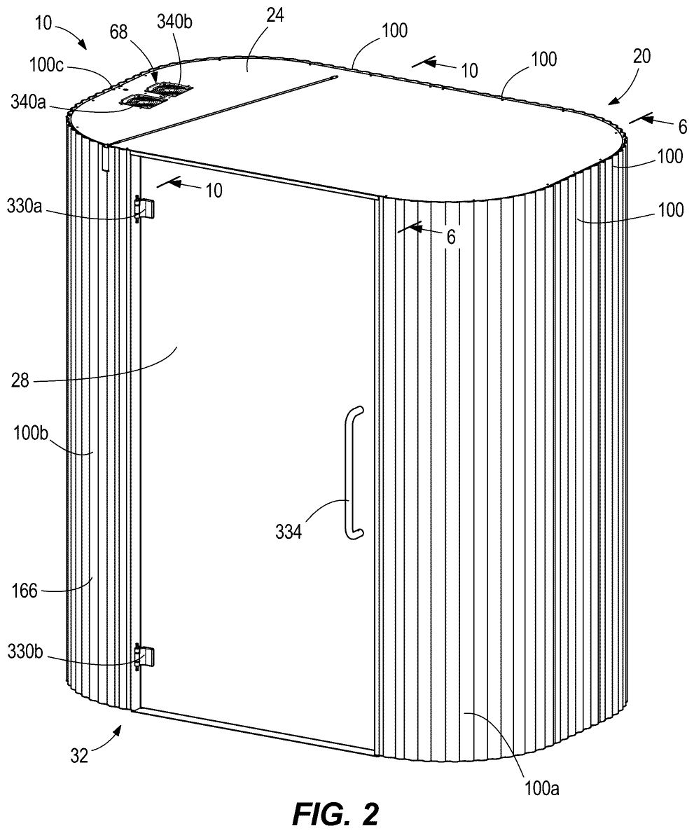

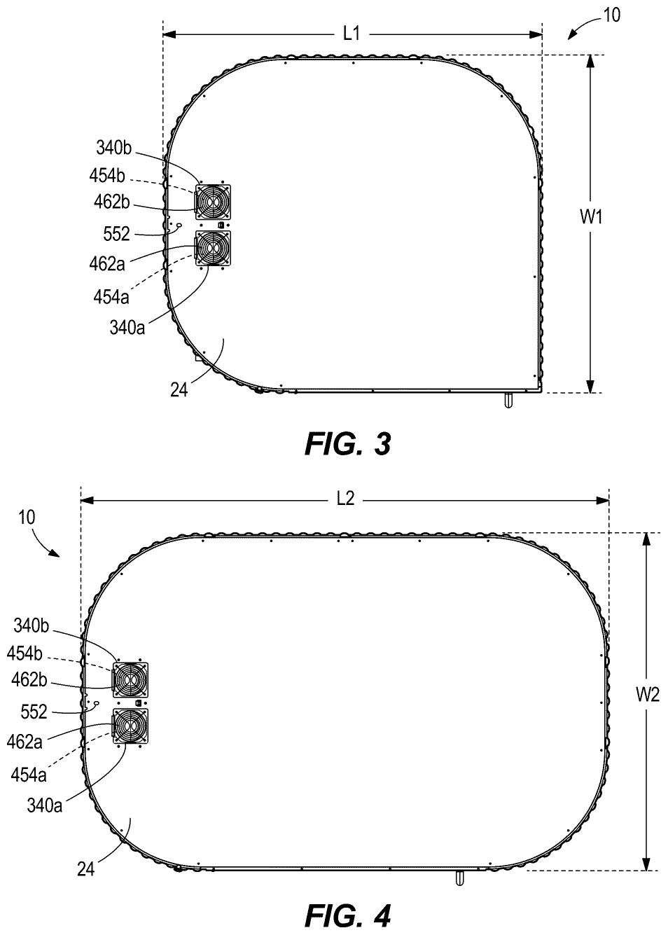

FIGS. 1 and 3 illustrate a privacy booth 10 according to one embodiment. FIGS. 2 and 4 illustrate a privacy booth 10 according to another embodiment. The privacy booths 10 disclosed herein are configured to be positioned within an open office space and to provide an enclosed, interior space for a user to conduct, for example, telephone and video conferences. The privacy booths 10 are configured to both reflect and absorb sound from the office space to inhibit sound from entering the interior of the privacy booth. The privacy booths 10 are configured to both reflect and absorb sound from the interior of the privacy booth to inhibit sound from leaving the same. Further, the privacy booths 10 are equipped with electronics systems 14 to connect users' electronic devices and power components of the privacy booths 10.

The privacy booth 10 of FIGS. 1 and 3 include the same features as the privacy booth 10 of FIGS. 2 and 4, except as noted herein. The primary difference between the privacy booth 10 of FIGS. 1 and 3 and the privacy booth 10 of FIGS. 2 and 4 is the size. As shown in FIG. 3, the privacy booth 10 may have a width W1 and a length L1. As shown in FIG. 4, the privacy booth may have a width W2 that is substantially the same as the width W1 and a length L2 that is greater than the length L1. The privacy booth 10 of FIGS. 2 and 4 is sized to be wheelchair accessible. In the illustrated embodiments, the width W1 and the width W2 measure approximately 1265 mm. In other embodiments, the width W1 and the width W2 measure approximately 1265 mm to approximately 1565 mm. In the illustrated embodiment, the length L1 measures approximately 1416 mm. In other embodiments, the length L1 measures approximately 1345 mm to approximately 1530 mm. In the illustrated embodiment, the length L2 measures approximately 1968 mm. In other embodiments, the length L2 measures approximately 1800 mm to approximately 1968 mm. The term approximately as used herein means plus or minus 25.4 mm. In view of the similarities between the privacy booths 10 of FIGS. 1 and 3 and FIGS. 2 and 4, only the privacy booth 10 of FIGS. 1 and 3 will be discussed, but the description applies of the privacy booth 10 of FIGS. 2 and 4 except as noted herein.

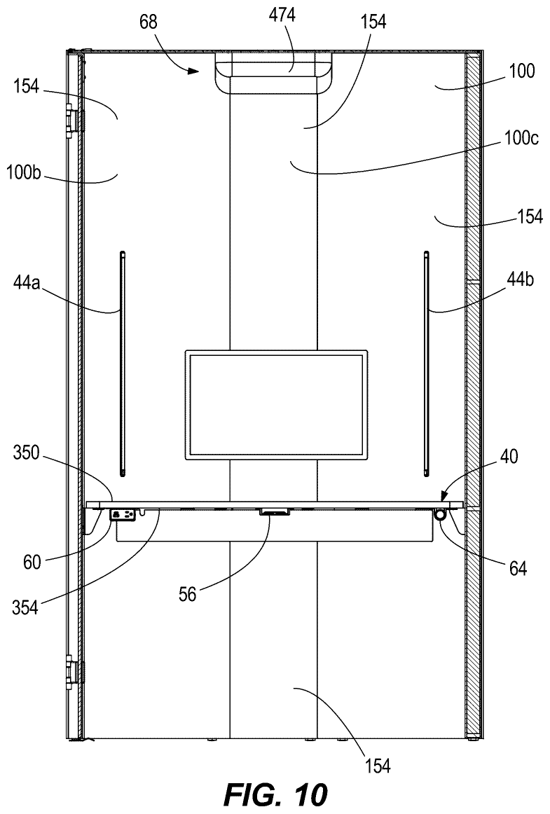

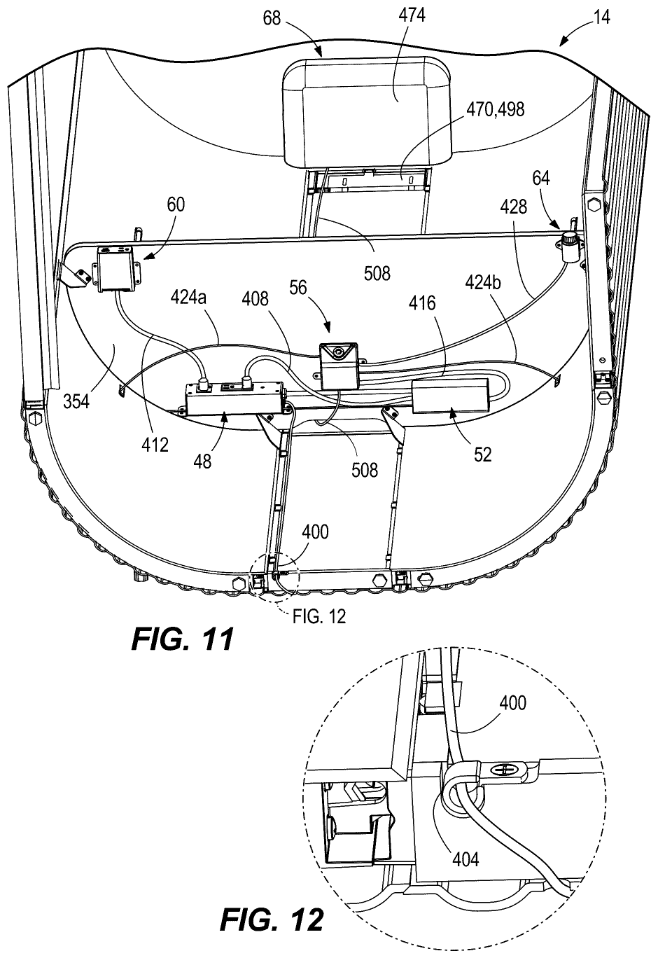

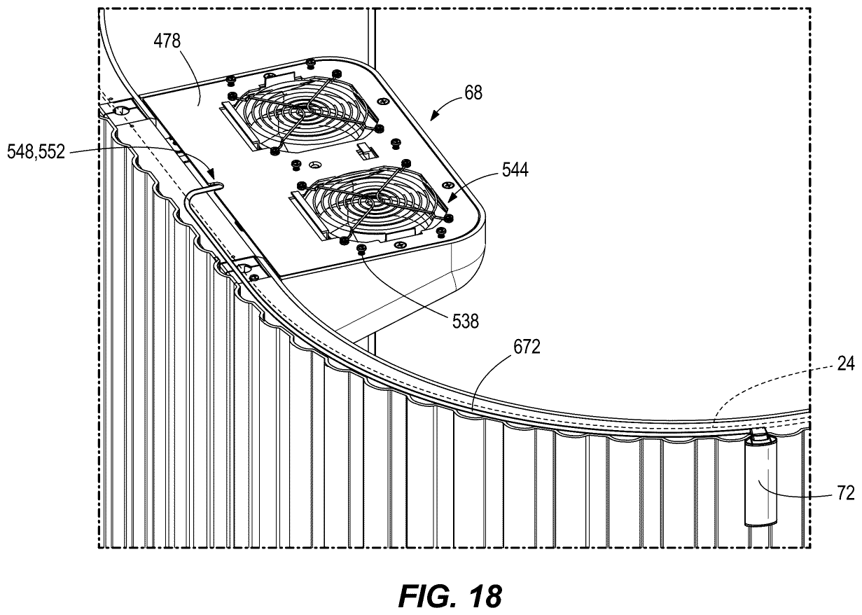

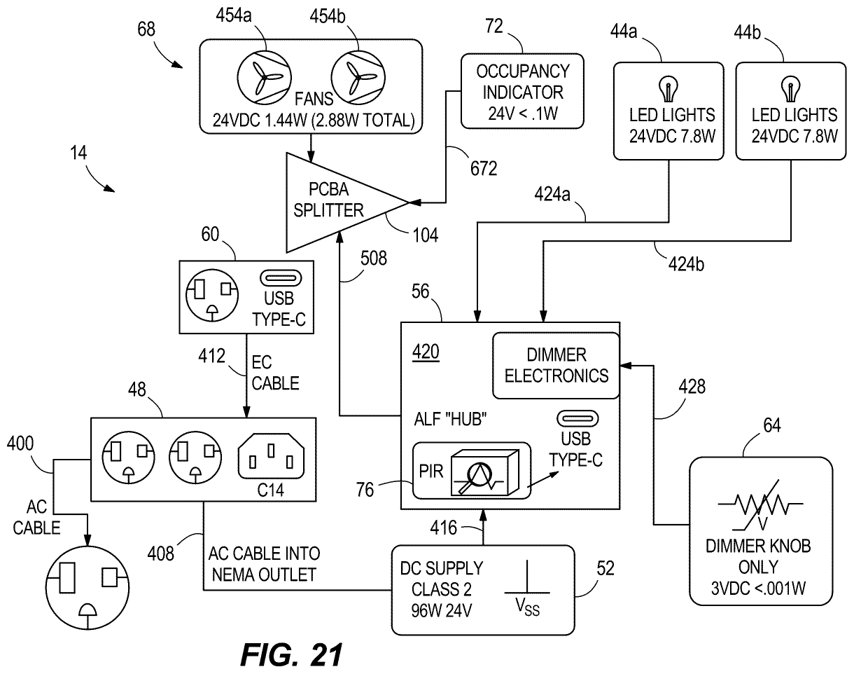

As shown in FIG. 1, the privacy booth 10 include a continuous wall 20, a ceiling 24 coupled to the wall, and a door 28 that permits entry into the privacy booth 10. The privacy booth 10 does not have a floor. Rather, the privacy booth 10 shares a floor of the office space or other room in which it situated. As such, a bottom of the privacy booth 10 is open. Also, a bottom edge of the continuous wall 20 is configured to be spaced apart from the floor of the office space. Therefore, a gap 32 is defined between the bottom edge of the continuous wall 20 and the floor of the office space on which the privacy booth 10 is supported. A height of the gap 32 ranges from 5 mm to 25 mm depending on the flatness of the floor of the office space. The gap 32 extends about the entire perimeter, in the illustrated embodiment. As shown in FIG. 10, inside, the privacy booth 10 includes a desk 40, a first light 44a, and a second light 44b supported by the continuous wall 20. Also, with respect to FIG. 11, an electronics system 14 is supported, in part, by the desk 40. The electronics system 14 (FIG. 21) includes an AC power supply 48, a DC power supply 52, a control hub 56, a user power supply 60, a dimmer switch 64, a ventilation system 68, an occupancy indicator 72 (FIGS. 18, 19, and 21), and a motion sensor 76 (FIG. 21), as well. In other embodiments, the electronics system 14 may include fewer or more components.

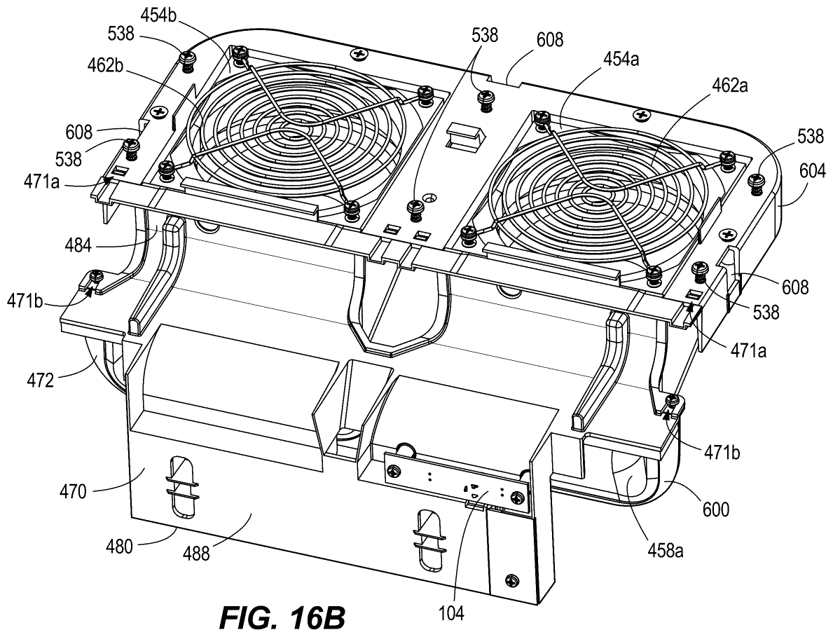

The privacy booth 10 is a generally rectangular shape. The smaller privacy booth 10 of FIGS. 1 and 3 has three rounded corners, while the larger privacy booth of FIGS. 2 and 4 has four rounded corners. The continuous wall 20 is defined by a plurality of panels 100 that are coupled to one another. The smaller privacy booth 10 of FIGS. 1 and 3 includes six panels 100, while the larger privacy booth 10 of FIGS. 2 and 4 includes eight panels 100. Each of the privacy booths 10 includes a first panel 100a and a second panel 100b on opposite sides of the door 28. Additionally, each of the privacy booths 10 includes a third panel 100c, which is configured to provide selective access to a connection port 102 (FIG. 20), which is in electrical communication with a printed circuit board (PCB) 104 (FIGS. 16 and 21) supported by the ventilation system 68. Some of the panels 100 are generally rectangularly-shaped, while other panels are generally arcuately-shaped. The arcuately-shaped panels 100 define the rounded corners of the privacy booth. The arcuately-shaped panels 100 have an inner radius of approximately 395 mm and an outer radius of approximately 445 mm. The inner radius may range from approximately 300 mm to 500 mm and the outer radius may range from approximately 350 mm to approximately 550 mm.

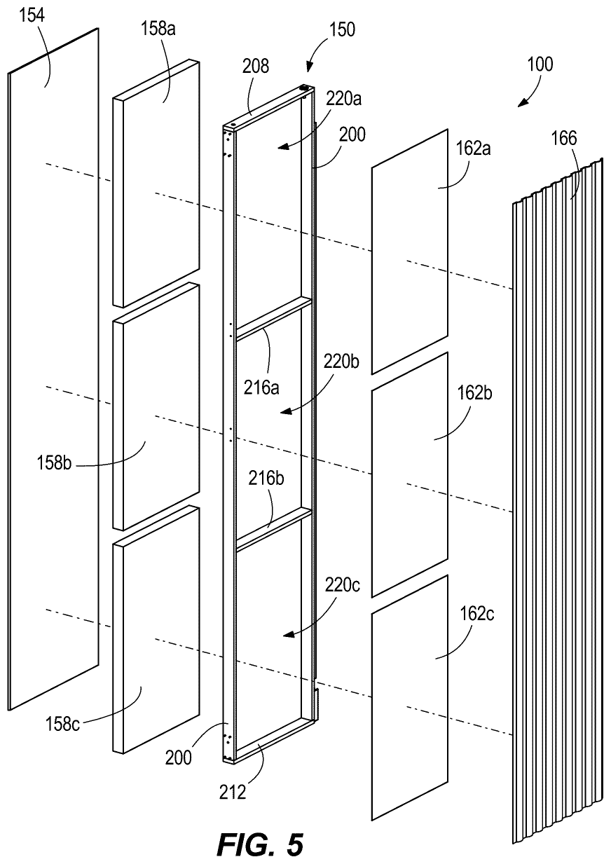

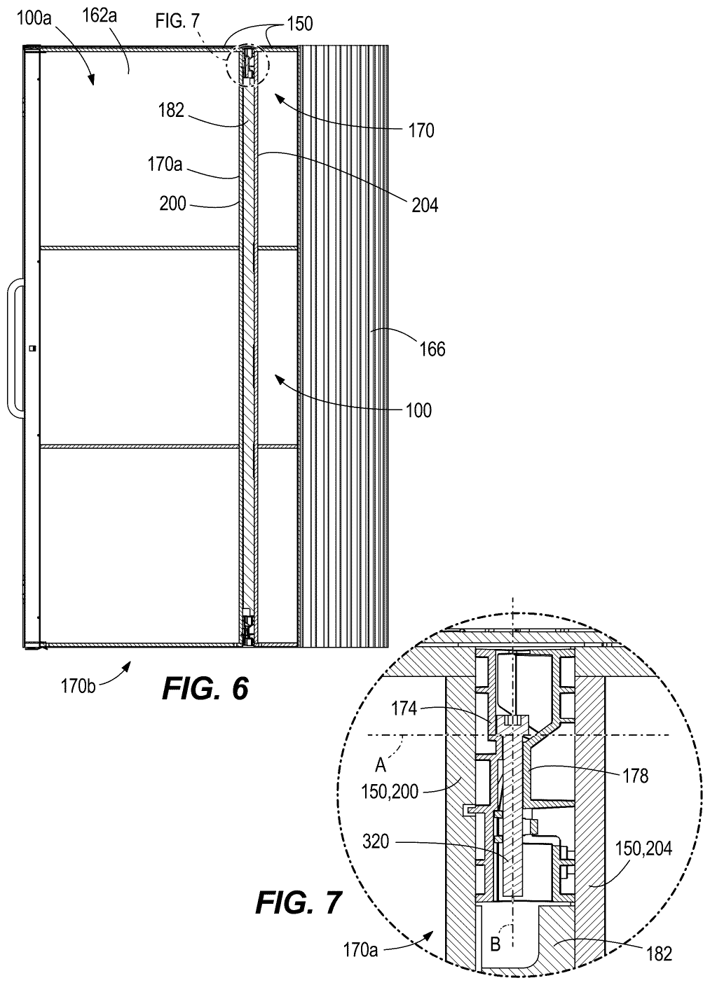

Each of the panels 100 has generally the same construction and therefore only a single panel 100 will be described in detail. Where there are differences to a panel 100, the differences will be noted. As shown in FIG. 5, the panel 100 includes a frame 150 that supports the following layers, from inside to outside, an inner wall member 154, a plurality of sound absorbing members 158a-158c, a plurality of metal members 162a-162c, and an outer wall member 166. The panels 100 are coupled to adjacent panels 100 via an upper connector 170a and a lower connector 170b (FIG. 6). As shown in FIGS. 7-9, each of the upper connectors 170a and the lower connectors 170b includes a first connector member 174 and a second connector member 178 that is coupled to the first connector member 174. The upper connector 170a includes a fastener that prevents removal of the first connector member 174 and the second connector member 178 before the ceiling 24 is coupled to panels 100. A seal member 182 is positioned between adjacent frame 150 members. The seal member 182 is positioned between the upper and lower connector 170a, 170b. The inner wall members 154 collectively define an inner wall of the privacy booth 10, and the outer wall members 166 collectively define an outer wall of the privacy booth 10.

Referring back to FIG. 5, in the illustrated embodiment, the frame 150 includes a first side 200, a second side 204 opposite the first side 200, an upper end 208, and a lower end 212. The frame 150 also includes a first separator 216a and a second separator 216b that extend between the first side 200 and the second side 204. The first and second separators 216a, 216b divide an interior of the frame 150 into a first section 220a, a second section 220b, and a third section 220c. One of the plurality of sound absorbing members 158a-158c and one of the plurality of metal members 162a-162c corresponds to each of the first, second, and third sections 220a-220c. In the illustrated embodiment, the sound absorbing members 158a-158c are positioned within the interior of the frame 150 and, in this case, within the corresponding section 220a-220c. Accordingly, in the illustrated embodiment, the plurality of sound absorbing members 158a-158c includes a first sound absorbing member 158a corresponding to the first section 220a, a second sound absorbing member 158b corresponding to the second section 220b, and a third sound absorbing member 158c corresponding to the third section 220c. Similarly, in the illustrated embodiment, the metal members 162a-162c are positioned within the interior of the frame 150 and, in this case, within the corresponding section 220a-220c. The plurality of metal members 162a-162c includes a first metal member 162a corresponding to the first section 220a, a second metal member 162b corresponding to the second section 220b, and a third metal member 162c corresponding to the third section 220c. In other or additional embodiments, the frame 150 may include more or fewer sections 220a-220c and there may be more or fewer sounding absorbing members 158a-158c and more or fewer metal members 162a-162c.

With respect to each of the panels 100 except the third panel 100c, the outer wall member 166 is fixedly coupled to the frame 150 and the inner wall member 154 is fixedly coupled to the frame 150. Also, the outer wall member 166 and the inner wall member 154 are formed from a single piece of material. With respect to the third panel 100c, the outer wall member 166 is fixedly coupled to the frame 150 and the inner wall member 154 is removably coupled to the frame 150. Also, in the illustrated embodiment, the outer wall member 166 is formed from a single piece of material, while the inner wall member 154 is formed from two pieces of material. In the illustrated embodiment, the inner wall member 154 (including both pieces of material) is magnetically coupled to the frame 150.

For each of the panels 100, the frame 150, the sound absorbing members 158a-158c, and the metal members 162a-162c are positioned between the outer wall member 166 and the inner wall member 154. Additionally, for each of the panels 100, the outer wall member 166 and the inner wall member 154 extend at least partially beyond an outer perimeter of the frame 150. In the illustrated embodiment, the outer wall member 166 extends above and below the upper and lower ends 208, 212 of the frame 150 and past the first and second sides 200, 204 of the frame 150. The inner wall member 154 extends below the lower ends of the frame 150 and past the first and second side 200, 204 of the frame 150. An upper end of inner wall member 154 is flush with the upper end 208 of the frame 150.

The frame 150 is formed from plywood, although another suitable material may be used instead. The inner wall member 154 and the outer wall member 166 are constructed from a plastic material. In the illustrated embodiment, the plastic material is polyethylene terephthalate (PET), but another suitable plastic material may be used instead. The inner wall member 154 is plate-shaped and therefore both the first and second sides are generally flat. The outer wall member 166 is formed with corrugations. As shown, the corrugations are arranged consecutively horizontally, such that each of the corrugations extends along the length of the privacy booth. In the illustrated embodiment, the pitch of the corrugations is 50.8 mm, although in other embodiments, the pitch of the corrugations may be different. The pitch of the corrugations drives the widths W1, W2 and the lengths L1, L2. The sound absorbing members 158a-158c are formed from cellulose, although another suitable material may be used. The metal members 162a-162c are formed from steel, but another suitable material may be used instead. The metal members 162a-162c are thin and are plate shaped.

As stated above, the panels 100 are coupled to adjacent panels 100 via the upper and lower connectors 170a, 170b. The first panel 100a includes, on the first side 200, the first connector member 174 of the upper connector 170a and the first connector member 174 of the lower connector 170b. The second panel 100b includes, on the second side 204, the second connector member 178 of the upper connector 170a and the second connector member 178 of the lower connector 170b. The other panels 100 each include, on the first side 200 of the frame 150, the first connector member 174 of the upper connector 170a and the first connector member 174 of the lower connector 170b and, on the second side 204 of the frame 150, the second connector member 178 of the upper connector 170a and the second connector member 178 of the lower connector 170b.

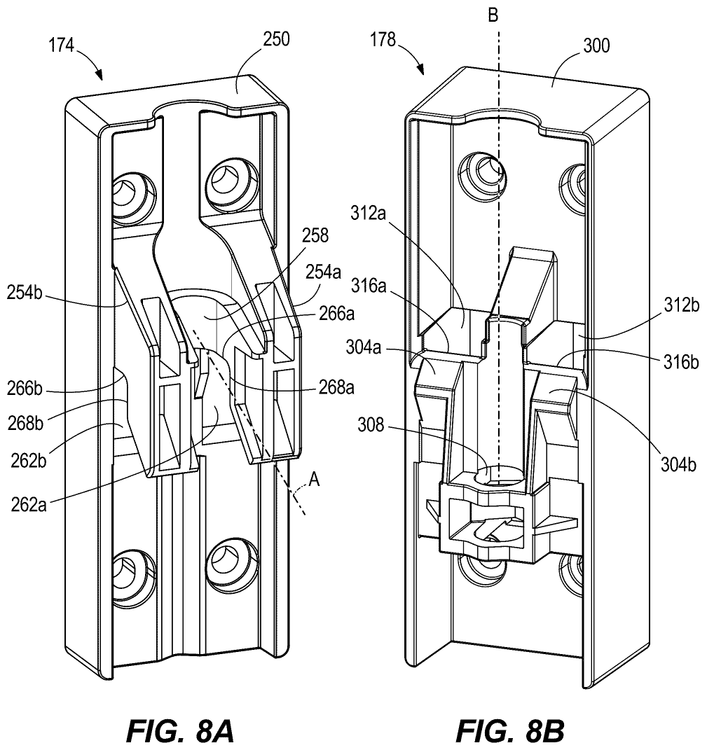

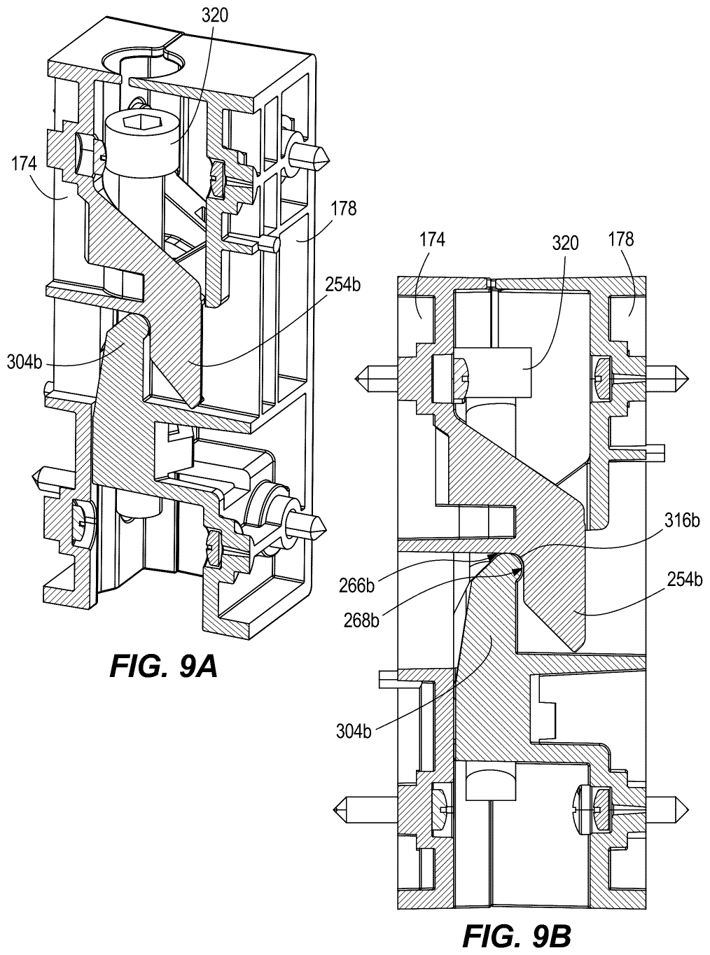

With respect to FIG. 8A, the first connector member 174 includes a body 250, a first projection 254a, second projection 254b, a slot 258, a first opening 262a, and a second opening 262b. The first and second projections 254a, 254b extend from the body 250 and are parallel to one another. With respect to FIG. 9B, each of the projections 254a, 254b includes horizontal surface 266a, 266b and a vertical surface 268a, 268b. The slot 258 is defined between the first projection 254a and the second projection 254b and has an axis A (FIG. 8A), which is perpendicular to a length of the body 250 and to the sides of the frame 150. The first opening 262a extends through the body 250 and is positioned behind the first projection 254a, and the second opening 262b extends through the body 250 and is positioned behind the second projection 254b.

With respect to FIG. 8B, the second connector member 178 includes a body 300, a first projection 304a, a second projection 304b, an aperture 308, a first opening 312a, and a second opening 312b. The first and second projections 304a, 304b extend from the body 300 and are parallel to one another. The aperture 308 is defined between the first projection 304a and second projection 304b and has an axis B, which extends along a length of the body 300 and is parallel to the sides of the frame 150. The first opening 312a extends through the body 300 and is positioned behind the first projection 304a, and the second opening 312b extends through the body 300 and is positioned behind the second projection 304b. Each of the first and second openings 312a, 312b includes an arcuate surface 316a, 316b.

When coupled, the first and second projections 254a, 254b of the first connector member 174 are positioned within the corresponding first and second openings 312a, 312b of the second connector member 178. Similarly, the first and second projections 304a, 304b of the second connector member 178 are positioned within the corresponding first and second openings 262a, 262b of the first connector member 174. The respective arcuate surfaces 316a, 316b of the projections 304a, 304b of the second connector member 178 are configured to engage, respectively, both the horizontal surfaces 266a, 266b and the vertical surfaces 268a, 268b of the corresponding projections 254a, 254b of the first connector member 174. Additionally, the aperture 308 is positioned below the slot 258. The axis B extends through the slot 258 and is perpendicular to the axis A of the slot 258. An edge of the slot 258 is positioned generally above the first and second projections 304a, 304b of the second connector member 178. The horizontal surfaces 266a, 266b of first connector member 174 engage the arcuate surfaces 316a, 316b of second connector member 178 to control the vertical location of the panels 100 relative to each other in a vertical plane. The vertical surfaces 268a, 268b of the first connector member 174 act against the arcuate surfaces 316a, 316b of second connector member 178 to control the horizontal location of the panels 100 relative to each other in a horizontal plane. Mating faces of the body 250, 300 also control horizontal movement. When coupled, a fastener 320 may extend through the slot 258 and aperture 308. In the illustrated embodiment, only the upper connector 170a includes the fastener 320. Such an arrangement facilitates assembly and disassembly of the privacy booth 10, where only the upper connector 170a may be accessible by a tool. The lower connector 170b may be blocked by other parts of the panels 100 and, therefore, not accessible with a tool to manipulate a fastener.

With renewed respect to FIGS. 1 and 2, the door 28 is hingedly coupled to the second panel 100b. In the illustrated embodiments, the door 28 is coupled to the second panel 100b using self-closing hinges 330a, 330b. As shown the door 28 is constructed from a transparent or opaque material. The material may be glass, plastic (e.g., Polycarbonate), a combination of glass and plastic, or any other transparent, semi-transparent, or opaque material. In the illustrated embodiment, the door includes two glass layers on opposite sides of a plastic (e.g., Polyvinyl butyral (PVB)) layer. The door 28 has a handle 334.

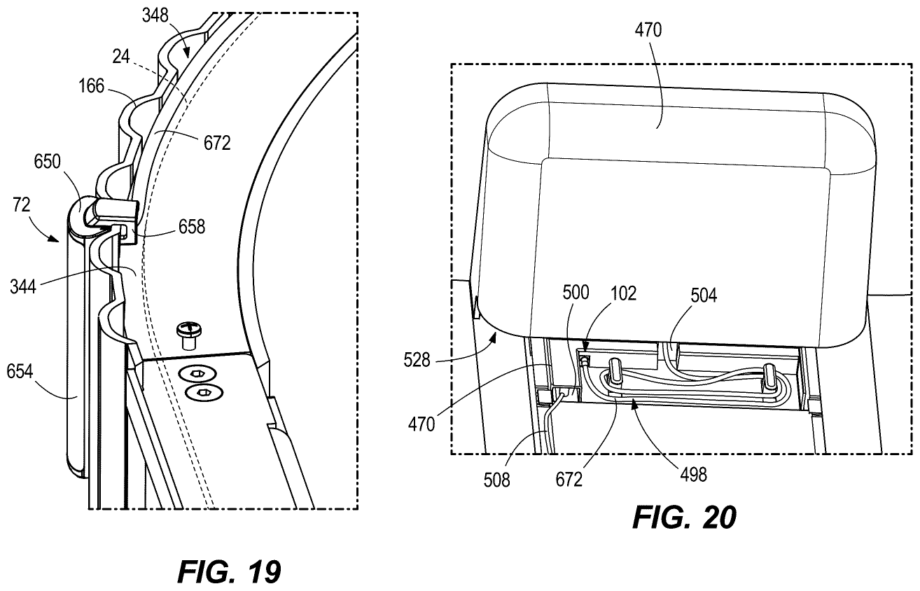

The ceiling 24 is a formed from a transparent or opaque material. The material may be plastic, such as Polycarbonate or any other suitable plastic. As shown in FIGS. 3-4, the ceiling 24 includes a first opening 340a and a second opening 340b, each of which is configured to accommodate a portion of the ventilation system 68, as will be discussed in greater detail below. As shown in FIG. 19, the ceiling 24 is positioned on a portion of the upper ends 208 of the frames 150. An outer edge 344 of the ceiling 24 is spaced apart from the outer wall member 166 of each of the panels 100 such that a gap 348 exists between the outer wall member 166 and the ceiling 24. Fasteners couple the ceiling 24 to the upper ends 208 of frame 150s of the panels 100.

The panels 100 are assembled such that each of the metal members 162a-162c and the sound absorbing members 220a-220b are inserted into the frame 150. Specifically, each of the first metal member 162a, second metal member 162b, and third metal member 162c is positioned within the corresponding first section 220a, second section 220b, and third section 220c of the frame 150. The metal members 162a-162c are in contact with or otherwise adjacent to the outer wall member 166. The sound absorbing members 158a-158c are also inserted into the frame 150. Specifically, each of the first sound absorbing member 158a, second sound absorbing member 158b, and third sound absorbing member 158c is positioned within the corresponding first section 200a, second section 220a, and third section 200c of the frame 150. Each of the sound absorbing members 158a-158c is configured to be in contact with or otherwise adjacent to the corresponding metal member 162a-162c. As shown, when assembled, the sound absorbing members 158a-158c and metal members 162a-162c are enclosed between the outer wall member 166 and the inner frame 150 member and within the frame 150. The first and second connector members 174, 178 are coupled (e.g., fastened with fasteners) to the respective sides 200, 204 of the frame 150. Once the panels 100 are assembled, the panels 100 can be coupled to one another by coupling the first connector members 174 to the respective second connector members 178. The fastener 320 couples each of the upper connectors 170 to prevent the panels 100 from moving relative to one another. The door 28 is then coupled to the second panel 100b via the hinges 330a, 330b. Then the ceiling 24 is coupled to the upper ends 208 of the frame 150 of the panels 100 via fasteners.

The rounded corners of the privacy booth 10 and the use of corrugations in the outer wall enables some office noise and noise within the privacy booth to be absorbed and/or deflected, rather than entering or leaving the interior of the privacy booth 10. Sound that is not absorbed may be reflected in multiple directions, dispersing the sound.

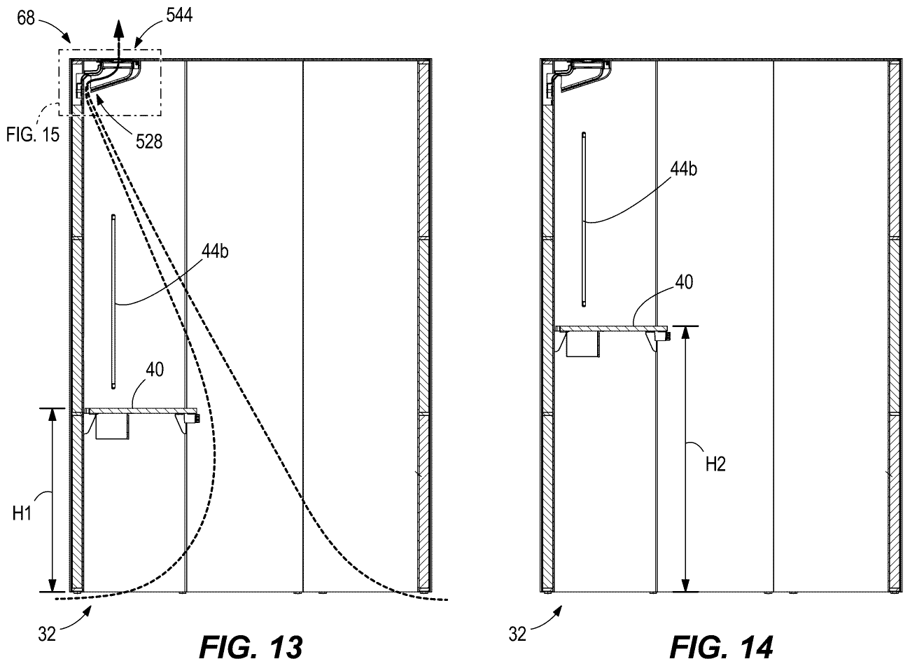

As shown in FIG. 10, the privacy booth 10 includes a desk 40, or worksurface, that is coupled to the inner wall. The desk 40 includes a first surface 350 and a second surface 354 opposite the first surface 350. The first surface 350 is an upper surface of the desk 40. The second surface 354 is a lower surface of the desk 40. With respect to FIGS. 13 and 14, the desk 40 may be positioned at a first height H1 or a second height H2. When the desk 40 is positioned at the first height H1, the user can sit at the desk 40 while electronic devices and other personal items are supported by the first surface 350 of the desk 40. The first height H1 measures approximately 723 mm in the illustrated embodiment but may be approximately 698 mm to 748 mm. When the desk 40 is positioned at the second height H2, the user can stand at the desk 40 while electronic devices and other personal items are supported by the first surface 350 of the desk 40. The second height H2 measures approximately 1064 mm in the illustrated embodiment but may be approximately 1104 mm to 1024 mm. The desk 40 is fixed at each height H1, H2 in these embodiments, but in other embodiments, the desk 40 may be movable between the first height H1 and H2. The second surface 354 supports the AC power supply 48, the DC power supply 52, the control hub 56, the user power supply 60, and the dimmer switch 64.

With respect to FIGS. 11 and 21, the AC power supply 48 has a main power cord 400 extending therefrom. A distal end of the main power cord 400 is configured to couple to an electric outlet of the office space to provide power to the privacy booth 10. The main power cord 400 is configured to be stored behind the inner wall member 154 of the third panel 100c and exit the privacy booth 10 via an aperture 404 in the frame 150 of the third panel 100c. The inner wall member 154 of the third panel 100c is removable to provide access to the main power cord 400. The AC power supply 48 is in electrical communication with the DC power supply 52 via a DC power cord 408 to power the DC power supply 52. The AC power supply 48 is in electrical communication with a user power supply 60 via a user power cord 412 to provide power to the user power supply 60. The user power supply 60 can have one or more ports for powering one or more electronic devices. The AC power supply 48 can also include additional ports for powering one or more electronic devices. The DC power supply 52 is in electrical communication with the control hub 56 via a control power cord 416 for providing power to the control hub 56. The control hub 56 includes a controller 420 (FIG. 21) for controlling the lights 44a, 44b, the ventilation system 68, the occupancy indicator 72, the dimmer switch 64, and the motion sensor 76, as will be discussed herein.

As shown in FIG. 10, the first light 44a is coupled to the inner wall and the second light 44b coupled to the inner wall. The first and second lights 44a, 44b are each mounted to one of the arcuate panels 100. Each of the first and second lights 44a, 44b extend vertically along the respective inner wall member 154. The first and second lights 44a, 44b are positioned approximately 91 mm above the first surface of the desk 40 in the illustrated embodiment. In other embodiments, the lights 44a, 44b may be positioned approximately 0 mm to 200 mm above the desk 40. In the illustrated embodiments, the lights 44a, 44b each include a light power cord 424a, 424b (FIG. 11) with a first end coupled thereto and a second end coupled to the control hub 56. Accordingly, each of the lights 44a, 44b is configured to communicate with the controller 420. The dimmer switch 62 includes a dimmer power cord 428 (FIG. 11) with a first end coupled thereto and a second end coupled to the control hub 56. Accordingly, the dimmer switch 64 is configured to communicate with the controller 420. Via the controller 420, the first and second lights 44a, 44b are dimmable via the dimmer switch 64. In this case, the dimmer switch 64 is a knob that is rotatable to control the brightness of the first and second lights 44a, 44b, together. The dimmer switch 64 may have other configurations in other embodiments. Via the controller 420, the first and second lights 44a, 44b are also turned on and off via the motion sensor 76, as will be discussed below. The vertical lights 44a, 44b illuminate the user evenly vertically and causes no shadows. Similarly, the fact there are two lights 44a, 44b, one mounted centrally in each curved panel 100, allow even lighting in a horizontal plane on the user.

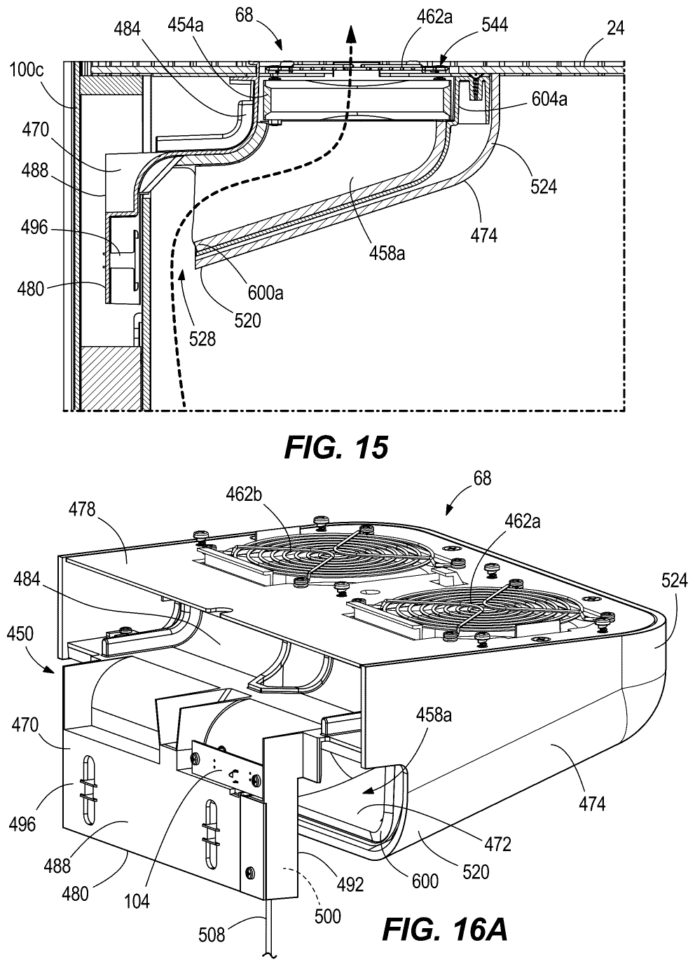

With respect to FIGS. 15-17, the ventilation system 68 is supported by the ceiling 24. The ventilation system 68 includes a fan housing 450, a first fan 454a, a second fan 454b, a first grille 462a, a second grille 462b, and the PCB 104. The fan housing 450 includes a rear housing member 470 and a front housing member 472. The ventilation system 68 further includes a first cover 478 and a second cover 474. The ventilation system 68 is supported by the ceiling 24. In particular, and as discussed in greater detail below, the first cover 478 couples the fan housing 450 to the ceiling 24.

FIGS. 15-17B show that the rear housing member 470 is supported by the ceiling 24 adjacent to the third panel 100c. The rear housing member 470 includes a first end 480 and a second end 484 spaced apart from the first end 480. The rear housing member 470 includes a rear wall 488 extending from the first end 480 and positioned within the interior of the frame 150. The rear wall 488 has a front surface 492 including the connection port 102 and a cable tidy 498 (i.e., a space for storing and organizing extra lengths of cords) (FIG. 20) and a rear surface 496 to which the PCB 104 is coupled. The rear wall 488 also has a first opening 500 and a second opening 504. An auxiliary power cord 508 extends from the PCB 104 through the first opening 500. The auxiliary power cord 508 is configured to be in electrical communication with the control hub 56. The PCB 104 and, therefore, the fans 454a, 454b are configured to communicate with the controller 420 such that controller 420 of the control hub 56 controls the fans 454a, 454b. A distal end of the auxiliary power cord 508 includes a connector that is received in a port of the control hub 56. The connection port 102, the cable tidy 498, and the auxiliary power cord 508 extending from the PCB 104 are hidden by the inner wall member 154 of the third panel 100c, but easily accessible, as necessary, because the inner wall member 154 is removably coupled to the frame 150. The rear housing member 470 is constructed from plastic, such as polycarbonate or polybutylene terephthalate (PTB).

Further with respect to FIGS. 15-17B, the front housing member 472 is coupled to the rear housing member 470 via both clips 471a and fasteners 471b. The front housing member 472 includes a first end 600, a second end 604 opposite the first end 600, a first channel 458a extending between the first end 600 and the second end 604, and a second channel 458b extending between the first end 600 and the second end 604. The front housing member 472 supports the first fan 454a within the first channel 458a and the second fan 454b with the second channel 458b. The first fan 454a and the first grille 462a are supported at or adjacent to the second end 604. As shown, the first fan 454a is adjacent to the first grille 462a. The second fan 454b and the second grille 462b are supported at or adjacent to the second end 604. The second fan 454b is adjacent to the second grille 462b. In other embodiments, the front housing member 472 may include a single channel for the two fans 454a, 454b. Additionally, in other or additional embodiments, there may be a single fan and a single channel or more than two fans and more than two channels. The front housing member 472 further includes a plurality of openings 608 (FIG. 16B). The first end 600 of the front housing member 472 is spaced apart from the inner wall member 154 of the third panel 100c. A gap 528 (FIGS. 13 and 15) between the first end 600 of the front housing member 472 and the inner wall member 154 of the third panel 100c defines an inlet of the ventilation system 68. The front housing member 472 is constructed from plastic, such as polycarbonate or polybutylene terephthalate (PTB).

Each of the rear housing member 470 and the front housing member 472 is coupled to the first cover 478. The first cover 478 couples the fan housing 450 to the ceiling 24 via fasteners 538. The first cover 478 includes a first opening 540a and a second opening 540b. The first opening 540a in the first cover 478 is aligned with the first opening 340a in the ceiling 24. The second opening 540b in the first cover 478 is aligned with the second opening 340b in the ceiling 24. The first grille 462a is positioned within the first opening 540a of the first cover 478 and extends across the first opening 540a. The second grille 462b is positioned within the second opening 540b and extends across the second opening 540b. The openings 540a, 540b in the first cover 478 collectively define an outlet 544 (FIGS. 13 and 15) of the ventilation system 68. As shown in FIG. 18, the first cover 478 also has an aperture 548 that is aligned with an aperture 552 in the ceiling 24. The first cover 478 is constructed from metal, such as steel.

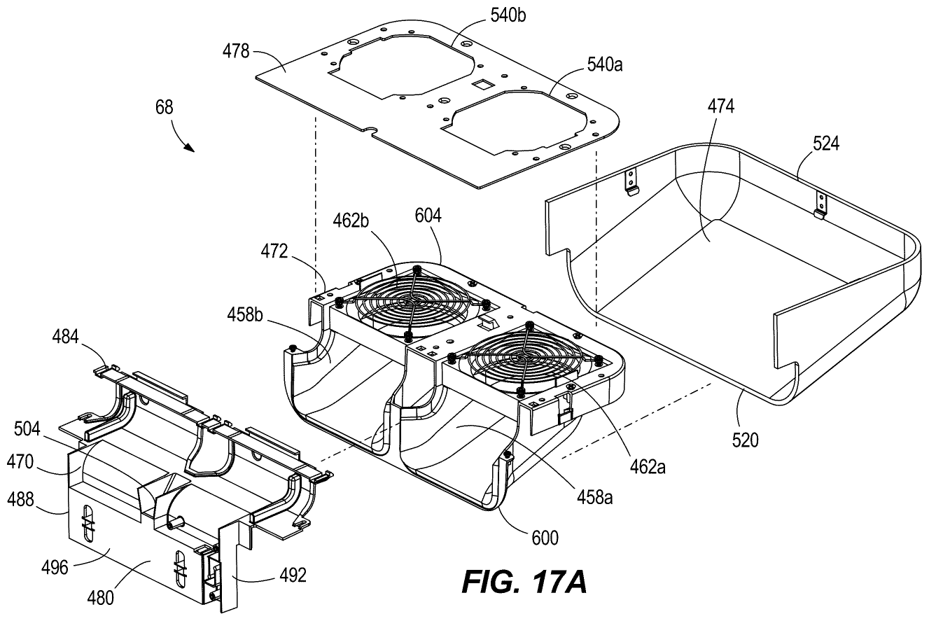

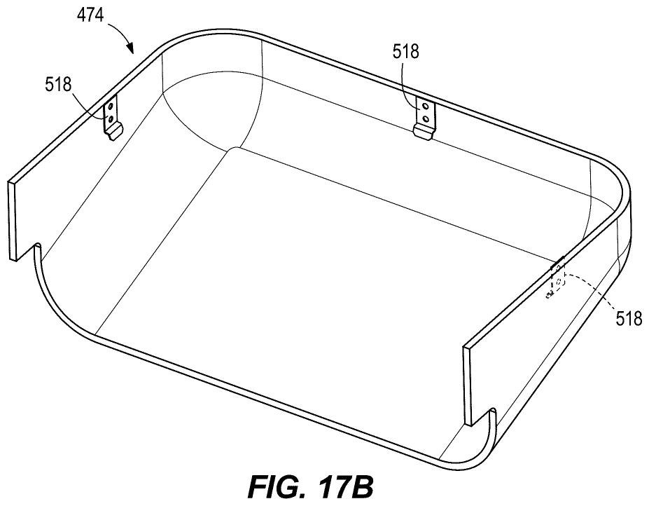

The second cover 474 is supported by the fan housing 450 and is positioned within the interior of the privacy booth 10. The second cover 474 is supported by the front housing member 472 in the illustrated embodiment. The second cover 474 includes projections or hooks 518 (FIG. 17B) that are received within a corresponding opening 608 of the first cover 478. The second cover 474 includes a first end 520 and a second end 524 that is spaced apart from the first end 520. The first end 520 is at or adjacent to the first end 600 of the front housing member 472. The first end 520 of the second cover 474 is also spaced apart from the inner wall member 154 of the third panel 100c. The second cover 474 is constructed from plastic, such as PET.

The ventilation system 68, via the fans 454a, 454b, is configured to draw air from exterior to the privacy booth 10 into the interior of the privacy booth 10 and then expel the air to the exterior of the privacy booth 10. The fans 454a, 454b suck air into the interior of the privacy booth 10 via the gap 32 between the privacy booth 10 and the floor of the office space or other room. The fans 454a, 454b move air upward through the interior of the privacy booth 10 to the inlet 528 of the fan housing 450 and into each of the channels 458a, 458b. Air moves through each of the fans 454a, 454b to the outlet 544 of the fan housing 450 and through the openings 340a, 340b in the ceiling 24 to exit the privacy booth 10. Accordingly, air moves generally vertically upward (e.g., from the floor to the ceiling 24) through the interior privacy booth 10 via operation of the fans 454a, 454b.

Referring to FIGS. 18 and 19, the occupancy indicator 72 is removably coupled to the outer wall of the privacy booth 10. The occupancy indicator 72 can be removed from the outer wall and re-coupled to any suitable position on the outer wall. Accordingly, a position of the occupancy indicator 72 can be customized to the layout of the any office space, such that it is visible to others. With respect to FIG. 19, the occupancy indicator 72 includes a body 650, a light source 654 (e.g., an LED) supported by the body 650, and a hook 658 extending from the body 650. The hook 658 receives an edge of the outer wall so that the body 650, with the light source 654, can sit in a trough between projections of the corrugations in the outer wall. The occupancy indicator 72 has an occupancy power cord 672 including a first end coupled thereto and a second end opposite the first end. The occupancy power cord 672 extends through the aligned apertures 548, 552 in the ceiling 24 and the first cover 478 and through the second opening 504 in the rear housing member 470 of the fan housing 450. The second end is coupled to the connection port 102 so that the occupancy indicator 72 can communicate with the PCB 104. The occupancy power cord 672 sits in the gap 348 between the ceiling 24 and the outer wall. Also, a length of the occupancy power cord 672 enables the occupancy indicator 72 to be movable about the perimeter of the privacy booth 10. Accordingly, depending on the placement of the occupancy indicator 72, the resulting slack in the occupancy power cord 672 can be wound around the cable tidy 498 of the rear wall member 470 of the fan housing 450 for storage. The occupancy power cord 672 of the occupancy indicator 72, with the cable tidy 498, is hidden by the inner wall member 154 of the third panel 100c, but easily accessible, as necessary, because the inner wall member 154 is removably coupled to the frame 150, as noted above. The occupancy indicator 72 is in electrical communication with the control hub 56 via the auxiliary power cord 508 that extends from the PCB 104 to the control hub 56. Accordingly, the occupancy indicator 72 is configured to communicate with the controller 420 such that the controller 420 controls the occupancy indicator 72.

The motion sensor 76 is within the control hub 56 and is configured to communicate with the controller 420. When the motion sensor 76 detects motion from a user entering the privacy booth 10, the motion sensor 76 is configured to send a signal to the controller 420 and the controller 420 is configured to send signals to the lights 44a, 44b and fans 454a, 454b to automatically turn on the same. Additionally, when the motion sensor 76 detects motion, the motion sensor 76 is configured to send a signal to the controller 420 and the controller 420 is configured to send a signal to the occupancy indicator 72 to automatically illuminate the same. The lights 44a, 44b, the fans 454a, 454b, and the occupancy indicator 72 will switch off after a predetermined amount of time of no motion being detected by the motion sensor 76. In some embodiments, the predetermined amount of time may be five minutes.

Although the invention has been described in detail with reference to certain preferred embodiments, variations and modifications exist within the scope and spirit of one or more independent aspects of the invention as described.

Various features of the invention are set forth in the following claims.

What is claimed is:

1. A privacy booth for use in a room, the privacy booth supported by a floor of the room, the privacy booth comprising:
a continuous wall comprising a plurality of panels coupled to one another, the continuous wall having a bottom edge that is configured to be spaced apart from the floor to define a gap therebetween;
a ceiling coupled to the continuous wall;
a door coupled to the continuous wall to enclose an interior and to selectively provide access to the interior; and
a ventilation system supported by the ceiling, the ventilation system including an inlet positioned within the interior and an outlet adjacent to the ceiling and in communication with an exterior,
wherein the ventilation system is configured to draw air into the interior from the exterior through the gap, draw the air from the interior into the inlet, and expel the air through the outlet to the exterior.

2. The privacy booth of claim 1, wherein the continuous wall and the door define a perimeter of the privacy booth, and wherein the gap is defined between the perimeter and the floor.

3. The privacy booth of claim 1, wherein the ventilation system is configured to move the air generally vertically from the floor to the ceiling through the interior.

4. The privacy booth of claim 1, wherein the ventilation system includes
a fan housing supported by the ceiling and defining the inlet and the outlet, and
a fan supported by the fan housing adjacent to the outlet.

5. The privacy booth of claim 4, further comprising a controller and a motion sensor configured to communicate with the controller, and wherein the ventilation system is configured to communicate with the controller, the controller configured to turn on the fan upon detection of a user by the motion sensor.

6. The privacy booth of claim 5, further comprising an occupancy indicator configured to communicate with the controller, and wherein the controller is configured to turn on the occupancy indicator upon detection of the user by the motion sensor.

7. The privacy booth of claim 5, further comprising a light positioned within the interior and configured to communicate with the controller, and wherein the controller is configured to turn on the light upon detection of the user by the motion sensor.

8. The privacy booth of claim 1, wherein each of the plurality of panels includes a frame and, from inside to outside, an inner wall member, a sound absorbing member, a metal member, and an outer wall member.

9. A privacy booth for use in a room, the privacy booth supported by a floor of the room, the privacy booth comprising:
a continuous wall including a plurality of sound absorbing panels coupled to one another, the continuous wall having a bottom edge that is configured to be spaced apart from the floor to define a gap therebetween;
a ceiling coupled to the continuous wall;
a door coupled to the continuous wall to enclose an interior and to selectively provide access to the interior; and
a ventilation system supported by the ceiling, the ventilation system configured to draw air into the interior from an exterior through the gap and expel the air through an outlet adjacent the ceiling to the exterior.

10. The privacy booth of claim 9, wherein each of the plurality of sound absorbing panels includes a frame and, from inside to outside, an inner wall member, a sound absorbing member, a metal member, and an outer wall member.

11. The privacy booth of claim 10, wherein the sound absorbing member is formed from cellulose.

12. The privacy booth of claim 10, wherein the outer wall member includes a plurality of corrugations.

13. The privacy booth of claim 9, wherein a subset of the plurality of sound absorbing panels are arcuately-shaped.

14. The privacy booth of claim 9, wherein the ventilation system is configured to move the air generally vertically from the floor to the ceiling through the interior to the outlet.

15. A privacy booth for use in a room, the privacy booth supported by a floor of the room, the privacy booth comprising:
a continuous wall comprising a plurality of panels coupled to one another, the continuous wall having a bottom edge that is configured to be spaced apart from the floor to define a gap therebetween;
a ceiling coupled to the continuous wall;
a door coupled to the continuous wall to enclose an interior and to selectively provide access to the interior;
a control hub including a controller and a motion sensor in electrical communication with the controller; and
a ventilation system supported by the ceiling and including a fan in electrical communication with the controller, the fan configured to draw air into the interior from the exterior through the gap and expel the air through an outlet adjacent the ceiling to an exterior; and
wherein the controller is configured to turn on the fan upon detection of a user by the motion sensor.

16. The privacy booth of claim 15, wherein the ventilation system is configured to move the air generally vertically from the floor to the ceiling through the interior to the outlet.

17. The privacy booth of claim 15, further comprising an occupancy indicator configured to communicate with the controller, and wherein the controller is configured to turn on the occupancy indicator upon detection of the user by the motion sensor.

18. The privacy booth of claim 17, wherein the occupancy indicator is supported by an exterior surface of the continuous wall, and wherein the occupancy indicator is movable about a perimeter of the continuous wall to adjust a position thereof.

19. The privacy booth of claim 15, further comprising a light positioned within the interior and configured to communicate with the controller, and wherein the controller is configured to turn on the light upon detection of the user by the motion sensor.

20. The privacy booth of claim 15, further comprising a desk supported by the continuous wall within the interior, the desk including a power supply in electrical communication with the control hub.
